(19) United States
(12) Patent Application Publication
(10) Pub. No.: US 2008/0276294 A1
(43) Pub. Date: Nov. 6, 2008

(54) LEGAL INTERCEPT OF COMMUNICATION TRAFFIC PARTICULARLY USEFUL IN A MOBILE ENVIRONMENT

(76) Inventor: Charles J. Brady, Austin, TX (US)

Correspondence Address: ZAGORIN O'BRIEN GRAHAM LLP, 7600B NORTH CAPITAL OF TEXAS HIGHWAY, SUITE 350, AUSTIN, TX, 78731, US

(21) Appl. No.: 11/743,498

(22) Filed: May 2, 2007

(51) Int. Cl. G06F 19/00

(52) U.S. Cl. 726/1

(57) ABSTRACT

Methods, structures, and systems are disclosed for implementing legal intercept of data which provide real-time correlation of broadband user information to network addresses (or other identifiers) across multiple and different authentication systems and user databases. In certain embodiments, an intercept coordinator module interacts with each authentication system to determine real-time a target address for a target user device, which it then uses to update mediation devices, external databases, etc., involved in performing a lawful intercept under the CALEA process. Probes are not required within the network to perform authentication system captures. A modular interface system provides support for existing CALEA equipment, and support for implementing additional interface modules for new or updated CALEA equipment. Exemplary intercept coordinator modules may communicate with multiple AAA systems, in multiple different sub-nets or networks, including geographically distant networks, and provides for pooling of common CALEA equipment resources for use in multiple networks simultaneously.

### BACKGROUND

1. Field of the Invention

The present invention relates to the legal intercept of data traffic in a communications network, and particularly to the intercept of data traffic to and from target user devices in a mobile environment, and even more particularly to the intercept of IP traffic for target user devices having dynamically assigned addresses.

2. Description of the Related Art

Lawful interception (LI) is legally sanctioned official access to private communications, such as telephone calls, email messages, or web traffic. In general, LI is a security process in which a network operator or service provider gives law enforcement officials access to the communications of private individuals or organizations. Countries around the world are drafting or enacting laws to regulate lawful interception procedures, and standardization groups are creating LI technology specifications to allow for interoperability of equipment and systems. Traditionally such LI efforts were targeted to detect suspected criminal activities, but have become more urgent in recent years to combat increased terrorism activities.

The United States enacted the Communications Assistance for Law Enforcement Act (CALEA) in 1994 in response to requests for help from the law enforcement community. CALEA requires providers of commercial voice services to engineer their networks in such a way as to assist law enforcement agencies in executing wiretap orders. On Aug. 5, 2005, the Federal Communications Commission (FCC), in response to additional requests by the law enforcement community, extended CALEA compliance to include facilities-based internet service providers. This action recognized the increased diversity of communications being carried by the internet, including telephone service (e.g., voice over internet protocol (VOIP)), instant messaging, email, file downloads, video clips, and others, all of which are increasingly the subject of legal “wiretap” orders in addition to traditional land-line telephone communications, especially in light of the increased concerns about terrorist activities which may be coordinated using such communication networks, and in furtherance of increased government efforts to counter terrorism.

Many internet service provider networks utilize dynamically assigned internet protocol addresses (IP address) to a given user from an available pool of such IP addresses. For example, many internet service providers support dial-in access to their networks. In such a situation, when a user dials in and connects to their network, an IP address is assigned to their device (e.g., computer). This particular IP address may be associated with that user for as long as the user remains connected to their network, or may change periodically and a new IP address assigned. However, when the user disconnects from the network, the previously-assigned IP address is released back to the pool of available addresses, and may be assigned to another user. The use of dynamically assigned IP addresses is well known, and is supported by numerous commercially-available devices.

For example, the Dynamic Host Configuration Protocol (DHCP) is a widely-known process for automating the configuration of computers that use TCP/IP. DHCP is used by networked computers or other device (clients) to obtain IP addresses and other parameters such as the default gateway, subnet mask, and DNS server address from a DHCP server. It facilitates access to a network because these settings would otherwise have to be made manually for the client to participate in the network. Internet service providers frequently use DHCP to assign clients individual IP addresses. Many large networks, such as educational institutions and large corporate offices, also utilize DHCP to accommodate user devices, such as laptop computers, that are connected only occasionally to the network.

Referring now to FIG. 1, a system configuration 100 is shown which provides for legal intercept in a network which assigns a dynamic address to a user when logged in or otherwise connected to the network. A network 102 is shown, which includes an edge router 104 for providing access to the internet, by way of a signal path 120, to users connected to the network 102. One such commercially available edge router is the Cisco 7206 VXR Router, available from Cisco Systems, Inc., San Jose, Calif. Such users and their connected devices are represented by the “remainder of the network” 134. When connecting to the network 102, a user communicates with an authentication system 112, such as a Radius™ DNS server, by way of signal path 135, layer 2 or 3 switching device 108, and signal paths 128, 130. One such commercially available layer 3 switching device is the Cisco Catalyst 4006, available from Cisco Systems, Inc. The authentication system 112 verifies user credentials, such as a correct username and password, and assigns connection information, including an IP address. Once a user is authenticated and connected to the network, user data traffic for the internet is conveyed by way of the signal path 135, the layer 2 or 3 switching device 108, and signal paths 124, 122 to the edge router 104.

The system 100 also includes facilities for performing a legal intercept of a target user. A law enforcement agency 158 communicates with a mediation system 154 by way of a signal path 156. One such commercially available mediation system is the Xcipio IADF LI Mediation Server, available from SS8 Networks, San Jose, Calif. To initiate a legal intercept of a target user, the LEA provides warrant information which identifies the target of the warrant, described herein as the target user. The target user identifying information is entered into the mediation system 154, typically by a human operator using console terminal 155. The general role of the mediation system 154 includes providing target user address information to other devices in the network, collecting the intercepted data, and presenting it to the LEA in an accepted format.

To proceed with the legal intercept, the mediation system 154 initially provides a target user identifier to the probe device 114, which determines if the target user is connected to the network, and if so, ascertains a network address for the target user, and filters data traffic at this address to accomplish the intercept. In the network 102 depicted, the Radius DNS server 112 provides a user database which is accessed to authenticate a dial-in user. Queries by other portions of the network to this database, and responses generated in reply thereto, are conveyed over the signal paths 128, 130, and are passed through the tap device 110 which directs a copy of such traffic by way of signal path 132 to the probe device 114. The tap device 110 intercepts this traffic without interfering with the communication or timing of the traffic between the layer 2 or 3 switching device 108 and the Radius DNS server 112.

The probe device 114 is able to ascertain whether a given user is connected to the network, and also ascertain the network address of any connected user, by watching (i.e., “sniffing”) the traffic into and out of the Radius DNS server 112, and maintaining log files of all RADIUS user traffic. In addition, the probe device 114 receives a “copy” of all traffic passing through the tap device 106, either to or from the edge router 104, by way of the high-bandwidth signal path 126. If the target user is connected to the network 102, the probe device 114 can initiate an intercept of the target user's data traffic passing through the tap device 106 by filtering any traffic associated with the network address identifier for the target user that is conveyed to the probe device 114 using signal path 126. The intercepted data is conveyed to the mediation system 154 using signal path 136. The data is then formatted into one of several acceptable formats and either stored for later retrieval, or provided immediately to the LEA 158.

The mediation system 154 may be located, as is shown in FIG. 1, within a central administration site 152 which can control intercepts in more than one network. For example, a second network 142 is depicted which communicates with the mediation system 154 using a signal path 144. The logical signal paths 136, 144 are typically encrypted to prevent unauthorized access to the intercepted data, as well as to provide for secrecy as to the intended target of the intercept, and possibly to conceal that an intercept is even in progress or imminent. Typically such logical paths are implemented using VPN tunnels through the public internet, and may physically traverse signal path 120 to enter the network 102.

Because the tap/probe architecture of this system for providing legal intercepts, the magnitude of network traffic that must be sniffed inevitably requires that the probe device 114 be local to the network. This arises because all traffic passing through the tap device 106 must be “tapped” and conveyed to the probe device 114, and all traffic passing through the tap device 110 must also be “tapped” and conveyed to the probe device 114. As such, both signal paths 126, 132 must be extremely high bandwidth signal paths, which makes locating the probe device 114 within the network a veritable requirement of this configuration. Moreover, each network which is configured for legal intercept requires its own set of tap devices 106, 110 and its own probe device 114, which can together represent a significant capital cost for each network.

### SUMMARY

Generally the invention relates to improved methods and systems for implementing legal intercept of data which can provide real-time correlation of broadband user information to network addresses (or other identifiers) across multiple and different authentication systems and user databases. In certain embodiments, an intercept coordinator module interacts with each authentication system to determine in real-time a network address identifier for a target user of a legal intercept. For example, the intercept coordinator may match an Internet Protocol address with a specific user name, or other identifying information for the target user. Then, the intercept coordinator can update mediation devices, external databases, and other necessary programs involved in performing a lawful intercept under the CALEA process. The intercept coordinator may be software or hardware or a combination of both, and may be implemented as an identifiably separate device, or may be incorporated within another device, such as a mediation system or an edge router.

Different broadband service providers and universities often maintain varied AAA (authentication, authorization, and access) mechanisms in order to authenticate and allow access to a network by a user. In typical deployments of CALEA, probes are placed within the target network to perform AAA captures. This method is costly and supports only certain authentication protocols/systems. In contrast, an intercept coordinator in accordance with certain embodiments of the invention may directly communicate with one or more authentication systems, and it is not necessary to place probes within the network to perform AAA captures. This provides a significant cost savings in making a network CALEA compliant.

Exemplary embodiments of an intercept coordinator provide for a modular interface system to existing CALEA equipment, and support implementing additional interface modules for new or updated CALEA equipment as they become necessary. Such a capability affords changing network hardware or software systems, including support for new AAA systems, without requiring totally different CALEA hardware or software.

In addition, an intercept coordinator may communicate with multiple AAA systems, in multiple different networks, including geographically distant networks. This allows the pooling of common CALEA equipment resources for use in a number of networks simultaneously, rather than requiring partially or wholly separate CALEA systems for each different AAA system, which would increase cost and complexity.

In a broader context, and in one aspect, the invention provides a method for facilitating a lawful intercept of IP traffic for a target user. In certain embodiments, the method includes: (1) requesting a first authentication, authorization, and accounting system (AAA system) associated with a first sub-net to provide a network connection descriptor for a target user; (2) receiving the network connection descriptor for the target user from the first AAA system, said network connection descriptor comprising a network address identifier for a first device associated with the target user which is connected to the first sub-net, or comprising an indication that no device associated with the target user is connected to the first sub-net; and (3) conveying an intercept descriptor to a mediation module in response to any change in target user connection status, said intercept descriptor comprising a target address corresponding to the network address identifier, and further comprising a mediation command to indicate how the intercept descriptor should be processed to carry out the intercept of IP traffic for the first target device.

In some embodiments the method includes: (1) requesting the first AAA system to provide a network connection descriptor for the target user only in response to changes in connection status; and (2) receiving a network connection descriptor for the target user whenever such network connection status changes. In some embodiments the method includes querying a secondary server to determine the target address corresponding to the network address identifier if the network connection descriptor does not already include the target address. In some embodiments the method includes: (1) receiving from the first AAA system a network connection descriptor for a second device associated with the target user which is simultaneously connected to the first sub-net, or comprising an indication that the second device associated with the target user is no longer connected to the first sub-net; and (2) conveying an intercept descriptor to the mediation module in response to any change in connection status for the second device associated with the target user.

In another aspect, the invention provides a computer readable medium encoding instructions executable on a processor. In some embodiments, the instructions are arranged to: (1) request a first authentication, authorization, and accounting system (AAA system) associated with a first sub-net to provide a network connection descriptor for a target user; (2) receive the network connection descriptor for the target user from the first AAA system, said network connection descriptor comprising a network address identifier for a first device associated with the target user which is connected to the first sub-net, or comprising an indication that no device associated with the target user is connected to the first sub-net; and (3) convey an intercept descriptor to a mediation module in response to any change in target user connection status, said intercept descriptor comprising a target address corresponding to the network address identifier, and further comprising a mediation command to indicate how the intercept descriptor should be processed to carry out the intercept of IP traffic for the first target device.

In yet another aspect, the invention provides an intercept coordinator module. In some embodiments, the intercept coordinator module comprises: (1) a first interface for communicating with a first authentication, authorization, and accounting system (AAA system) associated with a first sub-net, for requesting and receiving from the first AAA system a network connection descriptor for any device associated with a target user and connected to the first subnet; and (2) a second interface for communicating with a mediation module, for conveying to the mediation module an intercept descriptor for any target user device if a received network connection descriptor represents a change in connection status of the target user; (3) wherein each network connection descriptor comprises a network address identifier for a device associated with the target user which is connected to the first sub-net, or comprising an indication that no device associated with the target user is connected to the first sub-net; and (4) wherein said intercept descriptor comprises a target address corresponding to the network address identifier and a mediation command to indicate how the intercept descriptor should be processed to carry out the intercept of IP traffic for the first target device.

In some embodiments the module includes a second interface for communicating with a second AAA system associated with a second sub-net, for requesting and receiving from the second AAA system a second network connection descriptor for the target user, said second network connection descriptor comprising a network address identifier for a second device associated with the target user which is connected to the first sub-net, or comprising an indication that no device associated with the target user is connected to the first sub-net. In some embodiments the module is implemented as instructions executable on a processor.

In yet another aspect the invention provides a method for facilitating a lawful intercept of IP traffic for a target user. In some embodiments the method includes: (1) for each of one or more sub-nets to which a target user is authorized to connect, querying an authentication, authorization, and accounting system (AAA system) associated with the sub-net to provide a respective network connection descriptor for any target user device that is connected to the sub-net; (2) in response to any received network connection descriptor that represents a change in target user connection status for any of the connected target user devices, forming a respective intercept descriptor corresponding to the network connection descriptor; and (3) conveying the respective intercept descriptor to a mediation module to carry out the intercept.

In yet another aspect the invention provides a system which includes a mediation module, and an intercept coordinator module logically coupled to the mediation module. The intercept coordinator module is for querying an authentication, authorization, and accounting system (AAA system) associated with a sub-net to provide a respective network connection descriptor for any device associated with a target user and connected to the sub-net, and in response to any change in connection status for any connected target user device, for conveying a respective intercept descriptor corresponding to the network connection descriptor to the mediation module to carry out the intercept.

The foregoing is a summary and thus contains, by necessity, simplifications, generalizations and omissions of detail. Consequently, those skilled in the art will appreciate that the foregoing summary is illustrative only and that it is not intended to be in any way limiting of the invention. Moreover, the inventive aspects described herein are contemplated to be used alone or in combination. Other aspects, inventive features, and advantages of the present invention, as defined solely by the claims, may be apparent from the detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1, labeled prior art, is a block diagram of a network configured to perform a legal intercept of network traffic.

FIG. 2 is a block diagram of a network configured to perform a legal intercept of network traffic in accordance with certain embodiments of the present invention.

FIG. 3 is a block diagram of a network configured to perform a legal intercept of network traffic in accordance with certain embodiments of the present invention.

FIG. 4 is a flow chart diagram of an exemplary method carried out by portions of the system depicted in FIG. 2 or 3.

FIG. 5 is a block diagram of a network configured to perform a legal intercept of network traffic for multiple sub-nets to multiple law enforcement agencies in accordance with certain embodiments of the present invention.

FIG. 6 is a block diagram of a network configured to perform a legal intercept of network traffic in a network having more than one AAA system and more than one AF device, in accordance with certain embodiments of the present invention.

FIG. 7 is a block diagram of a network configured to perform a legal intercept of network traffic in accordance with certain embodiments of the present invention.

FIG. 8 is a flow chart diagram of an exemplary method carried out by other portions of the system depicted in FIG. 7 and other figures.

The use of the same reference symbols in different drawings indicates similar or identical items.

### DESCRIPTION OF THE PREFERRED EMBODIMENT(S)

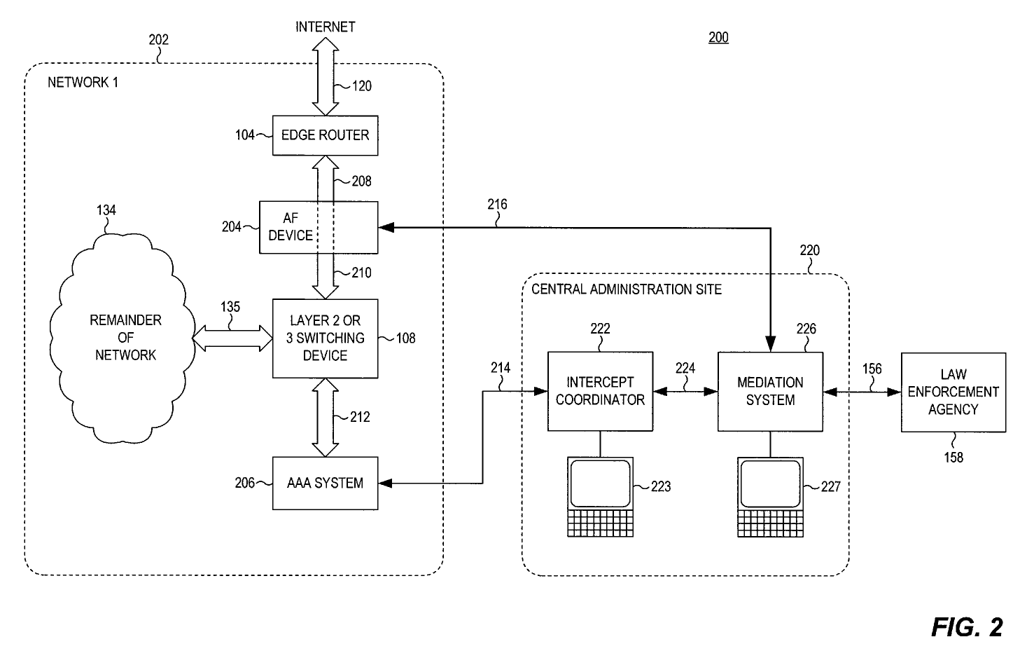

Referring now to FIG. 2, an exemplary system configuration 200 is shown which provides for legal intercept of a target user's network traffic, even in a network which assigns a dynamic IP address to a connected user. A network 202 is shown, which includes an edge router 104 for providing access to the internet, by way of a signal path 120, to users connected to the network 202. Such users and their connected devices are again represented by the “remainder of the network” 134. When connecting to the network 202, a user communicates with an authentication, authorization, and accounting system 206 (i.e., AAA system 206) by way of signal path 135, layer 2 or 3 switching device 108, and signal path 212. The AAA system 206 verifies user credentials, such as a correct username and password, and assigns connection information, including an IP address. Once a user is authenticated and connected to the network, user data traffic for the internet is conveyed by way of the signal path 135, the layer 2 or 3 switching device 108, and signal paths 208, 210 to the edge router 104.

To initiate a legal intercept of a target user, the LEA provides warrant information which identifies the target user, and a target user identifier is communicated to the intercept coordinator 222, typically by a human operator using console 223. The intercept coordinator 222 then interacts directly with the AAA system 206 to determine whether the target user is connected to the network, and if so, network connection information for the target user. In this embodiment, the intercept coordinator 222 queries the AAA system 206 with a specific target user identifier, such as by “logging in” to the AAA system with sufficient credentials. Such a target user identifier may include, for example, a user name, user account name, screen name, social security number, student identification number, etc. The target user identifier may also include a machine identifier, such as a MAC address (i.e., media access control address), port number, or IP address. If the target user is connected to the network, the query returns a network address identifier for the device associated with the target user. Such a network address identifier may include, for example, an IP address, a MAC address, or a port number. Conversely, if the target user is not connected to the network, the query returns an indication to that effect. One convenient indication that a target user is not connected to the network is an invalid network address identifier, such as an IP address of 0.0.0.0. If the network address identifier or other attribute reflects that a target user is not connected to the network, the intercept coordinator 222 waits until a subsequent communication from the AAA system 206, or a response to periodic query from the intercept coordinator, conveying a valid network address identifier, or until the intercept is canceled by the LEA.

There is no need for a tap device between the AAA system 206 and the layer 2 or 3 switching device 108 since the intercept coordinator 222 directly queries, and receives direct responses from, the AAA system 206 by way of signal path 214. Moreover, the bandwidth requirements of this signal path 214 are moderate, since only queries for specific target users (and the corresponding responses) are communicated over this path. There is no need to sniff all the traffic passing to and from the AAA system 206. This communication between the intercept coordinator 222 and the AAA system 206 may utilize an “out-of-band” communication channel, such as a dedicated data channel or a VPN tunnel, between the two modules. Such a VPN tunnel may be physically conveyed across the public internet and interface with the network 202 via signal path 120. Nevertheless, for clarity of description, the communication between the AAA system 206 and the intercept coordinator 222 is depicted as a signal path 214 between such two systems.

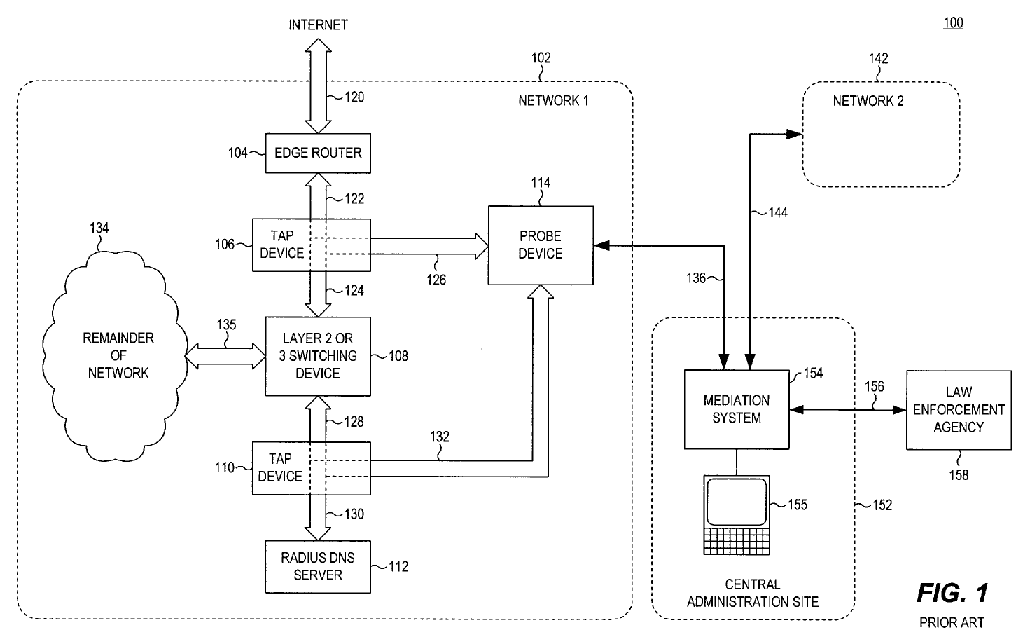

The intercept coordinator 222 then provides the target user network address identifier to the mediation system 226. This network address identifier, for a connected target user. is communicated to an access function device 204 (AF device 204), such as an edge router, to intercept traffic associated with the network address identifier and to convey such intercepted traffic back to the mediation system 226. Console 227 may be present on the mediation system 226, but is not utilized to enter target user information as was the case for the system shown in FIG. 1.

If the target user is connected to the network 202, the mediation system 226 issues commands to the AF device 204 by way of signal path 216 to initiate an intercept of the target user's data traffic passing through the AF device 204 either to or from the edge router 104. The intercepted data is conveyed back to the mediation system 226 using the same signal path 216 (in this embodiment). The data is then formatted into one of several acceptable formats and provided (either immediately or delayed) to the LEA 158.

The intercept coordinator 222 may be located, as is shown in FIG. 2, within a central administration site 220 along with the mediation system 226. The signal paths 214, 216 are typically encrypted to prevent unauthorized access to the AAA system 206 queries, as well as to prevent unauthorized access to the intercepted data itself. Such signal paths may be physically conveyed across the public internet and interface with the network 202 via signal path 120, but are depicted, for clarity of description, as logical signal paths between two associated systems.

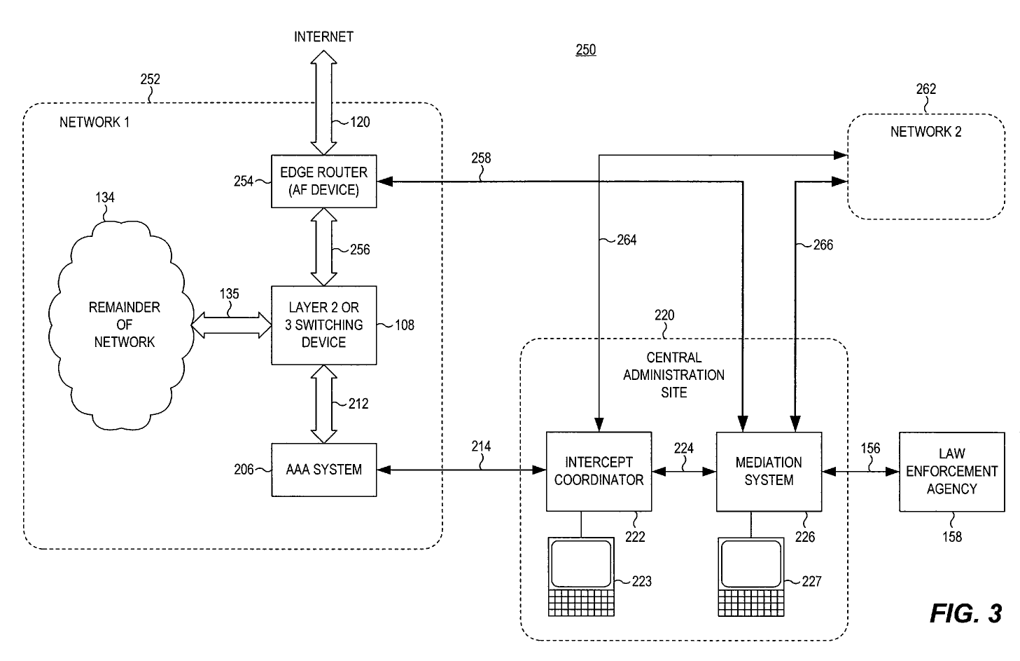

The AF device 204 is included in the network 202 to support the legal intercept capability, but no other high-bandwidth device or capability is necessary. Moreover, such an “access function” device need not necessarily be a separate device, as implied by FIG. 2, but can be provided within an edge router 254, as is shown for the network 252 depicted in FIG. 3. This decreases the cost of providing such a legal intercept capability even more, as there are no dedicated devices existing merely to support the legal intercept capability. Such routers are commercially available, such as from Cisco Systems, Inc. Many Cisco routers include their Service Independent Intercept (SII) capability to provide such access functionality within their routers.

In addition, the central administration site 220 may be utilized to control legal intercepts within more than one network. As shown in FIG. 3, a second network 262 is depicted which communicates with the intercept coordinator 222 using signal path 264, and which communicates with the mediation system 226 using signal path 266. Such a second network 262 may be located geographically with the first network 252, such as two networks on the same university campus. Alternatively, the second network 262 may be located geographically distant to the first network 252, such as two networks on different university campuses. Even though many embodiments described herein refer to university campuses, the invention is contemplated for use with other networks outside of higher education institutions.

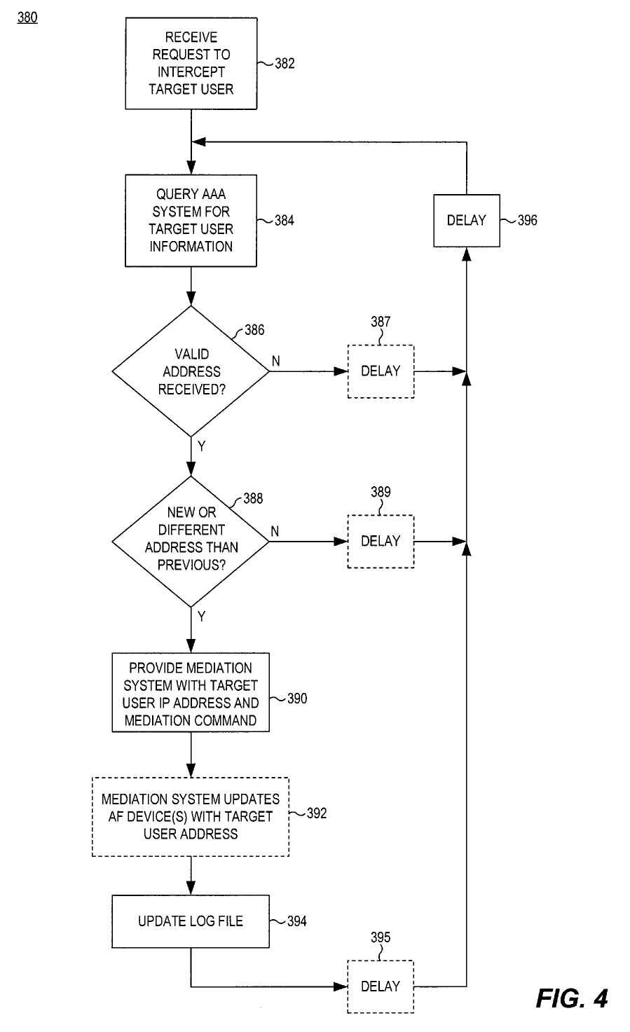

Referring now to FIG. 4, a flow chart 380 represents a simplified depiction of an exemplary operation of the intercept coordinator 222. At step 382, the intercept coordinator receives a request to intercept a target user. Such a request may be, for example, manually entered into the intercept coordinator by an operator, using the console terminal 223, acting in response to receiving a new warrant from an LEA, such as by fax, mail, courier, secure electronic medium, or other conveyance (not shown). The request communicated to the intercept coordinator may identify the target user by providing a target user identifier, which might, for example, include any of a user name, user account name, screen name, social security number, student identification number. In some embodiments, the target user identifier may specify a machine identifier, such as a MAC (i.e., media access control) address, port number, or an IP address.

At step 384, the AAA system for the network is queried to determine if the target user is connected to the network, and if so, to return a network address identifier for the target user. When information is received back from the AAA system, it is checked, at step 386, to determine if a valid IP address (or other network address indentifier) was received. If not, the system waits for a delay 396 (and optionally delay 387), then control passes to step 384 to query the AAA system again. Conversely, if a valid IP address is determined at step 386, it is checked to determine, at step 388, whether the IP address is new or different than the previous IP address for the target user. If not, the system waits for the delay 396 (and optionally delay 389), then control passes back to step 384 to query the AAA system again for information about the target user.

However, if the IP address is new or different than the previous IP address for the target user, the new IP address for the target user is communicated to the mediation system at step 390, along with a mediation command, to update the mediation system by appending or modifying the previously communicated IP address with the new IP address. Such a mediation command may include an ADD, APPEND, MODIFY, or DELETE command as appropriate, as further described herebelow. At step 392, shown as a dashed line, the mediation system would then update one or more associated AF device(s) to begin, continue, or terminate the intercept. At step 394, a log file is updated, and after the delay 396 (and optionally delay 395), control passes back to step 384 to query the AAA system again for information about the target user.

The various delay times represented by delay blocks 396, 387, 389, 395 may be chosen to balance the load of quickly repeated queries to the AAA system if the delays are very short, with unnecessarily long latencies in tracking any change in IP address for a target user, or the disconnection of a target user from the network, and the negative implications of such latencies regarding possible unintentional intercepts, errors in time-stamps of the intercept, and others. Exemplary delays may be from 0.5-2.0 seconds, although the individual constraints of a given system may suggest other values.

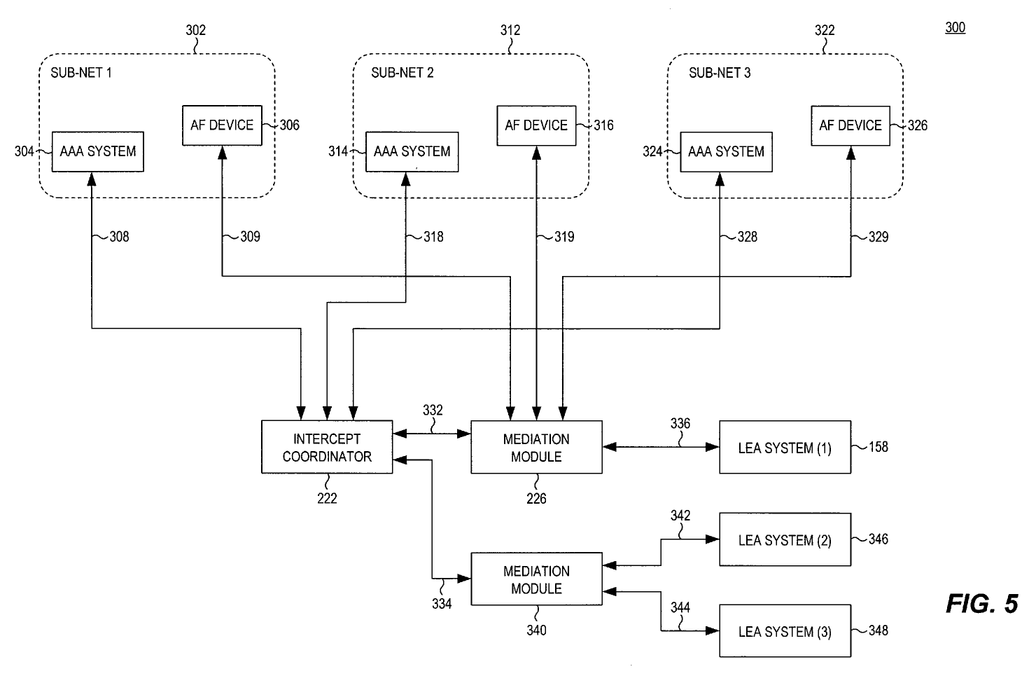

Referring now to FIG. 5, a system configuration 300 is shown which depicts an exemplary intercept coordinator 222 interacting with three different sub-nets 302, 312, 322. These sub-nets may all reside within a single network (e.g., the same university campus) or may reside within separate and possibly geographically distant networks (e.g., different universities). The intercept coordinator 222 communicates with AAA system 304 for sub-net 302 using signal path 308, with AAA system 314 for sub-net 312 using signal path 318, and with AAA system 324 for sub-net 322 using signal path 328. The intercept coordinator 222 communicates with a first mediation module 226 by way of signal path 332, and communicates with a second mediation module 340 by way of signal path 334. Such mediation modules may represent stand-alone hardware devices distinct from other devices (i.e., also described herein as a mediation server), or may represent functionality residing with another function. For example, an intercept coordinator and a mediation module may co-exist within the same device.

The first mediation system 226 communicates with AF device 306 for sub-net 302 using signal path 309, with AF device 316 for sub-net 312 using signal path 319, and with AF device 326 for sub-net 322 using signal path 329. The mediation system 226 also communicates with the LEA system 158 by way of signal path 336. The second mediation system 340 communicates with one or more AF devices for one or more sub-nets using various signal paths, none of which are shown here. The second mediation system 340 also communicates with a second LEA system 346 by way of signal path 342, and with a third LEA system 348 by way of signal path 344. As used herein, a sub-net is associated with a particular AAA system that controls devices connected to the sub-net, and which is also associated with one or more AF devices through which all data traffic for devices connected to the sub-net must pass. A sub-net forms all or a portion of a network.

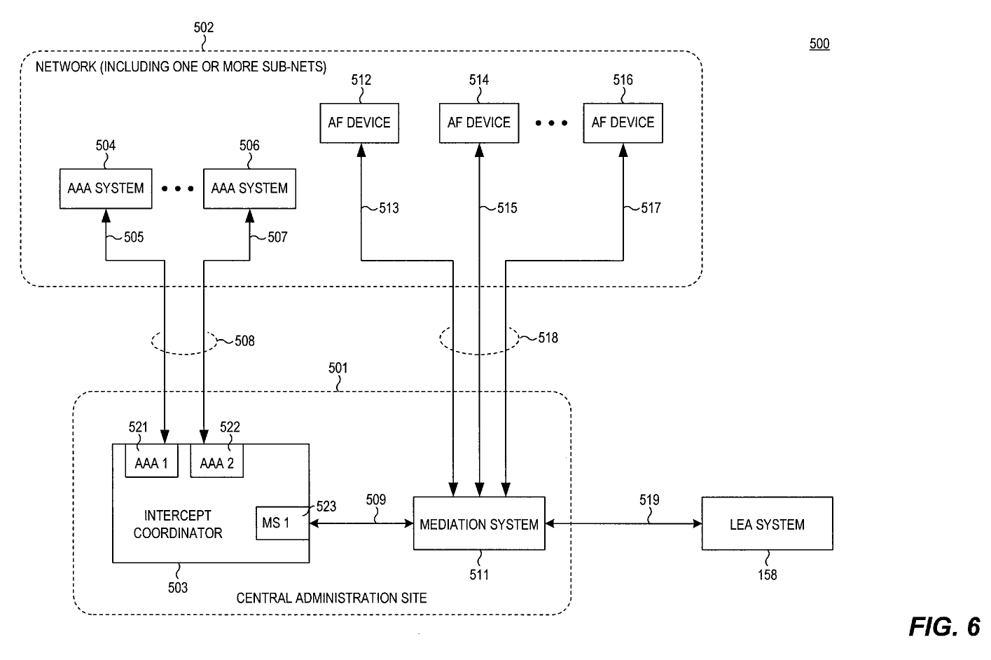

Referring now to FIG. 6, a system configuration 500 is shown which depicts a network 502 (including one or more sub-nets) having more than one AAA system and more than one AF device within the same network 502. An intercept coordinator 503 communicates with respective AAA systems 504, 506 using respective signal paths 505, 507, and communicates with a mediation system 511 by way of signal path 509. The mediation system 511 communicates with respective AF devices 512, 514, 516 using respective signal paths 513, 515, 517, and communicates with the LEA system 158 by way of signal path 519. While described as being separate, the signal paths 505, 507 may be conveyed together on a single path 508, which may represent an encrypted data channel conveyed over the internet to the network 502. Similarly, the signal paths 513, 515, 517 may be conveyed together on a single path 518, which may represent an encrypted data channel conveyed over the internet to the network 502. In addition, both signal paths 508, 518 may represent a single internet connection between the network 502 and the central administration site 501. As described above, such signal paths may actually be conveyed over the public internet and interface with the target network by way of the same edge routers that user traffic passes through.

When an intercept request is initiated by the LEA 158, the intercept coordinator 503 can query both AAA systems 504, 506 to see if the target user is connected to the network under control of either or both of these AAA systems. For example, a target user at a university network may have a desktop computer in a dormitory room that is connected to the network under control of a first AAA system, such as a RESNET system. In addition, the target user may have a laptop computer connected to the network using a wireless 802.11 connection in a classroom building or library on campus, under control of a second AAA system responsible for managing access to the campus wireless network. The same target user might also have a portable device such as a phone, PDA, or other mobile data device connected to the network. In such an environment, it is important to be able to check more than one AAA system for network connections for the same target user to respond to an intercept request for the target user.

In an exemplary system such as a large university, different portions of the overall network may have separate AF devices, or the same portion of the network may have more than one AF device simply for bandwidth load sharing purposes. Consequently, when a target user's network address is known, the structure of the network will dictate which AF device (or devices) the target user's traffic may flow through, and thus which AF devices must be configured to intercept a given target user. To accomplish this, the exemplary intercept coordinator 503 not only provides the target user address identifier to the mediation system 511, but for each such target user address identifier, may also provide information identifying which AF device(s) should be configured for the intercept of that address. Such identifying information may include an SNMP string for indicating the address (i.e., the AF address) and the communication credentials for the AF device. In this manner, the mediation system 511 can then communicate with the proper AF device(s) and provide the target user address identifier (e.g., IP address).

The intercept coordinator 503 may be configured to incorporate different software modules to interface with AAA systems from different vendors, or that utilize different protocols. Software interface module 521 is depicted as providing the interface to AAA system 504, and software interface module 522 is depicted as providing the interface to AAA system 506. In this manner, additional interface modules may be written as needed, such as when another AAA system is installed from a different vendor, without requiring significant hardware replacement, or significant re-engineering of other portions of the LI system. Similarly, the intercept coordinator 503 may be configured to incorporate different software modules to interface with mediation systems from different vendors, or that utilize different protocols. Software interface module 523 is depicted as providing the interface to mediation system 511. Such interface modules may be written as needed to interface to new or updated equipment. Each such interface module provides a common (i.e., uniform) internal interface to a central vendor-independent intercept coordinator code.

In exemplary embodiments, the intercept coordinator may communicate with a mediation server by logging-in to the mediation server and conveying an intercept descriptor to the mediation server. This intercept descriptor includes, for example, a target address for the intercept, and a mediation command to indicate how the intercept descriptor should be processed to carry out the intercept of IP traffic for the target device. Such a mediation commend may include an ADD command to indicate a new intercept (i.e., surveillance instance), a MODIFY command to change one or more parameters of an existing surveillance (e.g., a new IP address, a change in a collection function (LEA) parameter, a change in a router parameter, etc.), a DELETE command to indicate a target user is no longer connected to the network, or that the intercept is complete or has been cancelled, and an APPEND command to indicate a second device associated with the target user under an existing warrant (i.e., a secondary surveillance instance). Of course, many entries may be communicated to the mediation server to simultaneously provide for the intercept of many different target users. The intercept descriptor also may include additional information, such as the warrant number, an indentification of the LEA requesting the warrant, the address of the AF device (or perhaps multiple AF devices) to which the target address must be communicated to intercept data traffic for the target device, etc.

In response to receiving the intercept descriptor from the intercept coordinator, the mediation server (i.e., mediation module) typically may respond with a confirmation of the command, but other information typically need not be communcated back to the intercept coordinator. The operator console 227 for the mediation server may still be present, but may largely be unused since the intercept coordinator now provides the “directions” to the mediation server to carry out the intercepts.

For an exemplary system using IP addresses, if the target user has disconnected from the network, the appropriate AF device is updated by the mediation module to remove the target user IP address, and to thereby stop the intercept of that IP address. It should be noted that when a target user IP has changed, the appropriate AF device may change as well, and it may be necessary for the mediation system to remove the old target user IP address from the “losing” AF device, and add the updated target user IP address to the “gaining” AF device.

As the above examples show, the exemplary operation of the intercept coordinator provides independence of: (1) the number of devices a target user may have connected to a network; (2) the number of AAA systems controlling the network; (3) the number of AF devices serving the network; (4) the number of separate networks; (5) the number of mediation systems; and (6) the number of LEAs. Significantly, no additional hardware is required beyond the AF devices themselves (which may be incorporated within the edge routers, as described in FIG. 3) to accomplish the legal intercept. In particular, a high band-width probe device is not required alongside each AAA system, and/or alongside each AF device, as is required in the system shown in FIG. 1.

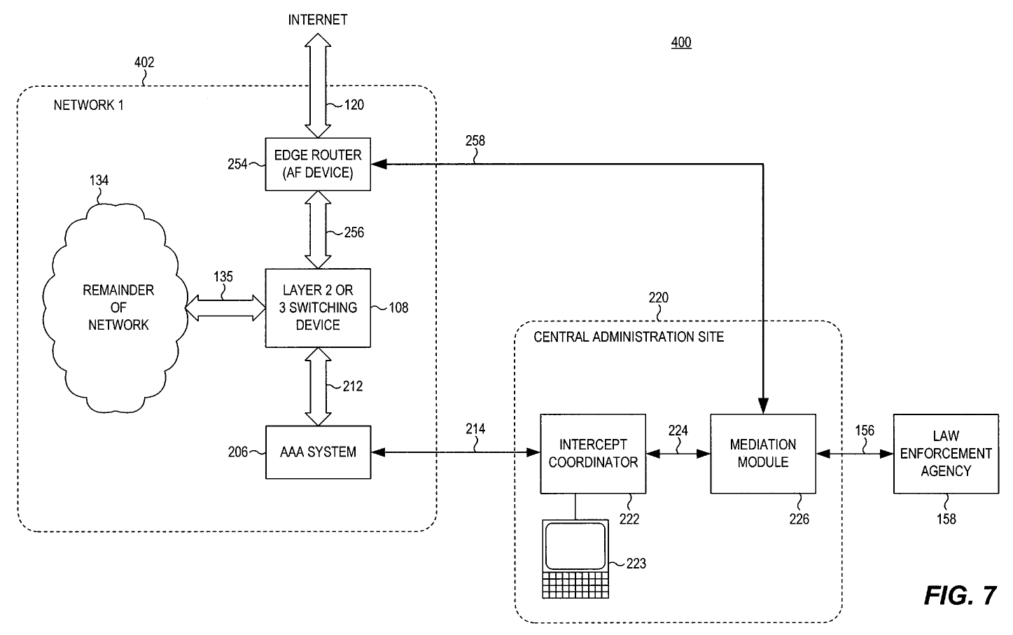

Referring now to FIG. 7, an exemplary system 400 is depicted to illustrate a “push” method of operation. A network 402 is shown, which includes an edge router 254 for providing access to the internet, by way of a signal path 120, to users connected to the network 402 (i.e., represented by the “remainder of the network” 134). When connecting to the network 402, a user communicates with a AAA system 206 by way of signal path 135, layer 2 or 3 switching device 108, and signal path 212. Once a user is authenticated and connected to the network, user data traffic for the internet is conveyed by way of signal path 135, layer 2 or 3 switching device 108, and signal path 256 to the edge router 254.

To initiate a legal intercept of a target user, the LEA provides warrant information which identifies the target user, which is then communicated to the intercept coordinator 222, as described in regards to FIG. 3. The intercept coordinator 222 then provides a target user identifier to the AAA system 206. However, the intercept coordinator 222 does not repeatedly query the AAA system 206, as before. In this exemplary system, the AAA system 206 “flags” or marks a target user who is subject to an intercept, and the AAA system 206 will automatically provide user connection information to the intercept coordinator whenever the target user first connects to the network, changes network address, or disconnects from the network. No periodic querying is performed by the intercept coordinator 222. Rather, the intercept coordinator 222 provides the target user identifier to the AAA system 206, and then waits for a response whenever the target user connection status changes.

The user connection information includes network address information, such as an IP address. Whenever the intercept coordinator 222 receives such network address information for the target user, it conveys the target user's current network address identifier to the mediation system 226 for logging and reporting purposes, and to coordinate the mediation system receiving the intercepted data traffic. The mediation system 226 then provides the network address identifier to the appropriate AF device (e.g., edge router 254) by way of signal path 258, to initiate, modify, or terminate the intercept. The AAA system 206 needs no further intervention from the intercept coordinator 222 to carry out the intercept of the target user. When the LEA cancels the intercept, the intercept coordinator conveys such information to the AAA system 206, which removes the target user from its target user table, and instructs the mediation system 226 (and thus the affected AF device(s)) accordingly.

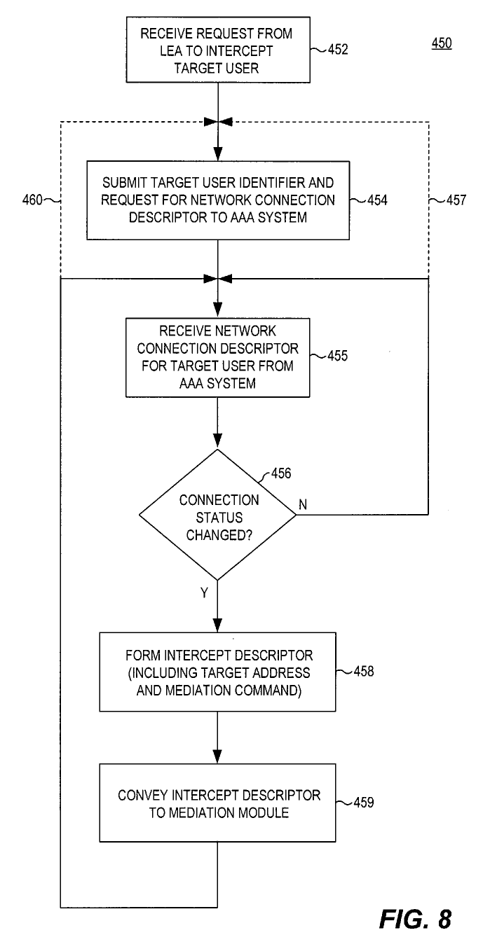

FIG. 8 is a flow chart 450 representing exemplary methods to carry out such a “push” functionality, as well as the above-described “pull” functionality. At step 452, the intercept coordinator receives a request from an LEA to intercept a particular target user. At step 454, the target user identifier is conveyed to the AAA system with a request for a network connection descriptor for the target user. When the network connection descriptor is received back from the AAA system at step 455, it is checked, at step 456, to determine if the target user connection status has changed (e.g., new connection, different address for the same target user, target user now disconnected from the network, etc.). If not, control passes back to step 455 to await an additional network connection descriptor from the AAA system for the target user. In a “pull” technique, subsequent network connection descriptors should be received from the AAA system whenever the connection status changes.

Conversely, if the target user connection status has changed, at step 458 an intercept descriptor is formed to include a target address and a mediation command (and potentially other optional components as described below). The target address may be identical to the network address identifier received from the AAA system. For example, if the AAA system provides as the network address identifier an IP address of the target device, and if the mediation module expects to receive IP addresses, such an IP address may be communicated without augmentation to the mediation module. In other circumstances, the target address may be derived from the network address identifier received from the AAA system. For example, if the AAA system provides as the network address identifier a MAC address of the target device, and if the mediation module expects to receive an IP address for a target address, the MAC address may be translated into an IP address by querying a DHCP server, or polling an ARP (i.e., querying an ARP table, such as maintained within a network switch), to form the target address within the intercept descriptor conveyed to the mediation module.

At step 459 the intercept descriptor is conveyed to the mediation module to either start, modify and continue, or terminate the intercept. Control then returns to step 455 to await the next network connection descriptor for the target user. If the target user has just disconnected from the network, and if the LI is still in place, the AAA system will provide another network connection descriptor when the target user reconnects to the network. If, at any time, a request is received from the LEA to terminate the intercept of the target user, the AAA system is informed (not shown), which “unflags” the target user, to thereby cease tracking changes in connection status of such target user.

Also shown in FIG. 8 are flow paths 457, 460 which correspond to a “pull” configuration. If control returns from step 459 back to step 454, and from step 456 back to step 454, the intercept coordinator submits another request from the AAA system. Each request results in a single response from the AAA system, which represents a “query” of the AAA system.

As can be seen from the above descriptions, in some embodiments the intercept coordinator queries periodically one or more AAA systems, requesting a network connection descriptor for the target user. The intercept coordinator typically maintains tables or other data base to determine which sub-nets a given target user has access to, and can query the appropriate AAA systems for these sub-nets when conducting a LI for the target user. The network connection descriptor includes an indication of whether the target user is connected to the system, either explicitly or by some indirect method, such as an invalid network address identifier (e.g., an IP address of 0.0.0.0). For a target user who is connected to the network, other examples of user information provided as part of a network connection descriptor include the identification of one or more AF devices through which data traffic to and from the target user device may pass. As described above, two or more such AF devices may be capable of routing traffic of the target user device, such as in a load sharing configuration, and thus both (or all) such AF devices must be configured for the intercept.

Another example of useful target user connection information that the AAA system may provide as part of the network connection descriptor is a bandwidth tag to indicate the maximum data rate of the target user device. When coupled with the identification of the AF device(s) appropriate for the target user device, necessary bandwidth may be reserved in the AF device to ensure that the full intercepted data stream may be transmitted to the mediation system, and ultimately delivered to the LEA. For example, if a target user has an input bandwidth of 5 Mb/s (i.e., mega bits per second), and an output bandwidth of 2 Mb/s, then a bandwidth reservation of 7 Mb/s may be placed for the outbound channel from the AF device to the mediation system. If such bandwidth is not available in the AF device to mediation system channel, then packet loss will occur in the intercepted data stream, resulting in an incomplete intercept of the data. The data rate of each potential target user device may be assigned by the AAA system, or otherwise may be a function of the provisioning of the data circuit used by the target device. In either case, the AAA system may provide such bandwidth information regarding each connected target user within a network connection descriptor for the target user. The intercept coordinator may provide this information directly to the corresponding AF device when initiating a legal intercept, or may provide this information as part of the intercept descriptor conveyed to the mediation system. This kind of information is sometimes known as “subscriber service level” information. Reserving bandwidth in this manner may be particularly important in a university or school environment, as the edge routers and/or other AF devices are frequently operated at a fairly high percentage of their capacity (i.e., operated “pretty full”).

In the above embodiments, it should be emphasized that a warrant for a target user may be accomplished for one or more devices associated with the target user. Multiple devices include one or more desktop computers, laptop computers, PDA's, smartphones, etc. The target user connection information received back from the AAA system is contemplated to include network address information (and related information concerning AF devices, data rate, etc.) for each of the devices found to be connected to the network that are associated with the target user. This may be accomplished by the AAA system providing a separate network connection descriptor for each connected target user device. For example, a single warrant may generate intercepts for two different IP addresses, and intercept data passing through three different AF devices. This is in stark contrast to the system shown in FIG. 1 which “sniffs” RADIUS start/stop packets because information about a second target user device connected to the network may over-write information about a first connected target user device, and thus prevent such a system from accomplishing a simultaneous intercept of more than one IP address for a target user. In addition, the methods described herein may be used with AAA systems incorporating the user database internal to the AAA system, where there is no traffic to “sniff.”

To reiterate somewhat, in certain cases each target user may require two or more AF devices to effectuate the legal intercept. Each AF device may be associated with its own AAA system. In other cases, each AF device may be associated with more than one AAA system, even though all the traffic passes through a single AF device. A single intercept coordinator may be used to communicate with every AAA system on an entire campus, and indeed for more than one campus. Thus, legal intercept capability may be provided very inexpensively for many different geographically separated networks using a single intercept coordinator, located in a central administration site that may be geographically distant from some or all of the networks.

Moreover, even though many embodiments described above contemplate dynamically assigned IP addresses, embodiments in which fixed IP addresses are encountered are also contemplated. For example, a university campus may include a separate AAA system for controlling computers within a classroom building which utilize static IP addresses to simplify the network controls and access permissions that may be placed on such computers. A target user, whether student, faculty, or staff, may be logged in to the campus network using one of these fixed IP address machines. In response to a query or command from an intercept coordinator, the appropriate AAA system may provide target user connection information, including, for example, whether the target user is logged in and, if, so, the network IP address, and the identification of one or more AF devices through which target user traffic would travel, and the provisioned data rate or the connection.

As used herein, an AF device represents a device through which data traffic passes, and which traffic may be filtered for a particular network address identifier and a copy of such filtered data sent to another destination, all without interruption of the data stream passing through the AF device. Frequently, an edge router is a convenient device within which to incorporate an “access function” because traffic to and from a large number of user's devices typically passes through such an edge router and is available for intercept. However, other AF devices are also contemplated, such as concentrators within a network, routers coupling two or more networks or sub-networks together (e.g., within a campus), and others.

As used herein, a module may be implemented in hardware or software. The term “mediation module” is used to convey the functional capability of a mediation system or server, irrespective of whether such functionally resides alone or in combination with other capabilities (e.g., with the intercept coordinator functionality, or within a router or other AF device). Two such modules may be hardware implemented in separate hardware devices (e.g., separate “boxes”), or within a single hardware device.

As used herein, a query requires initiating a transaction and receiving a response. For example, a query includes a transaction initiated by a first device (or module) to a second device (or module), to which a response is provided by the second device to the first device. Passively sniffing all data packets to and from a AAA system does not constitute querying the AAA system. In a broader context, a first system (or module) communicating with a second system (or module) requires each system to be “talking” and “listening” to the other. Passively sniffing all data packets to and from a AAA system does not constitute “communicating with” the AAA system. In certain networks, a DHCP server may be viewed as forming a part of the AAA system. For example, a user device may be assigned a routable IP address only after successful authentication on the network. In other circumstances, a DHCP system may be viewed independently of the AAA system. For example, the AAA system may provide a network address identifier which is a MAC address corresponding to the target user device. In response, the intercept coordinator may initiate a query to a DHCP server to translate the MAC address into an IP address, which is then included as part of the intercept descriptor conveyed to the mediation system. In this example, the DHCP server may be viewed as a secondary server to the AAA system. In other embodiments, “polling an ARP” may also provide a way to translate a MAC address into an IP address. Such are examples of translating the network address identifier (received as part of the network connection descriptor) into a target address conveyed as part of the intercept descriptor, when the network address identifier is not already in a suitable format for use as the target address.

While shown herein as different functional blocks, the intercept coordinator and the mediation system may be incorporated into a single device which provides the functionality of both. Furthermore, one or both such systems may be incorporated into an AF device.

As used herein, a target user device is a device where a target user is logged-in to the network, even if a public terminal or computer. Such devices may or may not be electrically connected to the network irrespective of whether a user is logged in, but as used herein, a device that is “connected to the network” means a device accessing the network under control of a AAA system, and not merely a device whose network cable is plugged in.

As used herein, a “tap-probe” method, such as described in regards to FIG. 1, mirrors the entire data stream at a location in the network, copying all such traffic (also known as “port replication” using a layer 1 tap) to a probe device, which may be implemented using a “Data Collection Filtering Device”. The probe device filters the traffic (by IP address, port number, of some other network address identifier) for a target user, and forwards the filtered IP traffic for eventual delivery to an LEA, usually by way of a mediation system. An example of a commercially available probe device is the DCFD 3500 IP Interception Solution, available from Top Layer Networks, Westboro, Mass.

The above descriptions mention AAA systems in the various embodiments. Many such AAA systems are known and used in the art. Examples include the Cisco Clean Access system (now known as the Cisco NAC Appliance), available from Cisco Systems, Inc., San Jose, Calif. Another AAA system is the Bradford Networks Campus Manager Solution and NAC Director products, available from Bradford Networks, Concord, N.H. Another AAA system is the Active Directory system within the Microsoft Windows environment, and the LDAP system. The RADIUS system described above may also be viewed as a AAA system, even though it usually includes only a AAA database of valid users/passwords and configuration information for each such user, and does not perform all the functions of a full-blown AAA system. It is also contemplated that a AAA system and a AF device may co-exist within the same hardware. An example of such an integrated system is the Nomadix Service Engine gateway, available from Nomadix Inc., Newbury Park, Calif. As used herein, a AAA system may represent one or more separable components, modules, databases, or servers, each of which is utilized to perform one or more of the traditional AAA functions. In other words, a AAA system may be “one box” or two or more interacting “boxes.”

As used herein, a campus is not necessarily a university or educational campus, but is intended to include corporate, governmental, or any other facility of one or more buildings located in close proximity together. As used herein, coupled means either directly or indirectly. The block diagrams herein may be described using the terminology of a single path connecting the blocks. Nonetheless, it should be appreciated that, when required by the context, such a “path” may actually represent multiple separate paths (e.g., connections) for carrying traffic and signals between modules. As used herein, a signal path may represent a logical path or a physical path, and a logical path is not necessarily a physical path. Two logical paths need not be conveyed over distinct physical paths.

The invention is contemplated to include systems, related methods of operation, related methods for making such systems, and computer-readable medium encodings of such systems and methods, all as described herein, and as defined in the appended claims. As used herein, a computer-readable medium may include a storage medium such as a disk, tape, or other magnetic, optical, semiconductor (e.g., flash memory cards, ROM), or electronic medium. A computer-readable medium may also include a transiently encoded form suitable for transmission via a network, wireline, wireless, or other communications medium.

The foregoing detailed description has described only a few of the many possible implementations of the present invention. For this reason, this detailed description is intended by way of illustration, and not by way of limitations. Variations and modifications of the embodiments disclosed herein may be made based on the description set forth herein, without departing from the scope and spirit of the invention. Moreover, the inventive aspects described above are specifically contemplated to be used alone as well as in various combinations. It is only the following claims, including all equivalents, that are intended to define the scope of this invention. Accordingly, other embodiments, variations, and improvements not described herein are not necessarily excluded from the scope of the invention.

What is claimed is:

1. A method for facilitating a lawful intercept of IP traffic for a target user, said method comprising:
requesting a first authentication, authorization, and accounting system (AAA system) associated with a first sub-net to provide a network connection descriptor for a target user;
receiving the network connection descriptor for the target user from the first AAA system, said network connection descriptor comprising a network address identifier for a first device associated with the target user which is connected to the first sub-net, or comprising an indication that no device associated with the target user is connected to the first sub-net; and
conveying an intercept descriptor to a mediation module in response to any change in target user connection status, said intercept descriptor comprising a target address corresponding to the network address identifier, and further comprising a mediation command to indicate how the intercept descriptor should be processed to carry out the intercept of IP traffic for the first target device.

2. The method as recited in claim 1 wherein:
said receiving the network connection descriptor from the first AAA system is carried out from a location remote from the first sub-net and the first AAA system.

3. The method as recited in claim 1 wherein the intercept descriptor further comprises a repective AF address for each of one or more access function devices associated with the first sub-net, and through which data traffic for the associated target device must flow.

4. The method as recited in claim 1 further comprising:
periodically requesting the first AAA system to provide a network connection descriptor for the target user; and
receiving a network connection descriptor for the target user in response to each request for such network connection descriptor.

5. The method as recited in claim 4 wherein the network address identifier comprises a valid network address if said target user device is connected to the first sub-net, and otherwise an invalid network address to indicate that no such target user device is connected to the first sub-net.

6. The method as recited in claim 5 wherein the network address identifier comprises a dynamically assigned IP address.

7. The method as recited in claim 6 wherein said requesting the first AAA system to provide a network connection descriptor for a target user comprises:
conveying a target user identifier to the first AAA system, said target user identifier comprising one of a user name, a user account name, a screen name, a social security number, and a student identification number.

8. The method as recited in claim 7 wherein:
said target user identifier further comprises one of a MAC address, a port number, or an IP address.

9. The method as recited in claim 1 wherein the network connection descriptor comprises a maximum bandwidth tag for the associated target device.

10. The method as recited in claim 1 further comprising:
requesting the first AAA system to provide a network connection descriptor for the target user only in response to changes in connection status; and
receiving a network connection descriptor for the target user whenever such network connection status changes.

11. The method as recited in claim 1 further comprising:
querying a secondary server to determine the target address corresponding to the network address identifier if the network connection descriptor does not already include the target address.

12. The method as recited in claim 1 further comprising:
communicating the target address to an access function device associated with the first sub-net.

13. The method as recited in claim 12 further comprising:
filtering the IP traffic associated with the target address and conveying a copy of such filtered IP traffic to the mediation module.

14. The method as recited in claim 1 further comprising:
receiving from the first AAA system a network connection descriptor for a second device associated with the target user which is simultaneously connected to the first sub-net, or comprising an indication that the second device associated with the target user is no longer connected to the first sub-net; and
conveying an intercept descriptor to the mediation module in response to any change in connection status for the second device associated with the target user.

15. The method as recited in claim 1 further comprising:
requesting a second authentication, authorization, and accounting system (AAA system) associated with a second sub-net to provide a network connection descriptor for the target user;
receiving from the second AAA system the network connection descriptor for the target user, said network connection descriptor comprising a network address identifier for a device associated with the target user which is connected to the second sub-net, or comprising an indication that no device associated with the target user is connected to the second sub-net; and
conveying an intercept descriptor to a mediation module in response to any change in connection status for the device associated with the target user and connected to the second sub-net.

16. The method as recited in claim 15 wherein:
the first and second sub-nets are part of a local area network for a single contiguous campus.

17. The method as recited in claim 15 wherein:
the first and second sub-nets are part of respective local area networks for geographically distant campuses.

18. The method as recited in claim 15 wherein communication with the respective AAA systems for the first and second sub-nets utilize different protocols.

19. A computer readable medium encoding instructions executable on a processor, said instructions arranged to:
request a first authentication, authorization, and accounting system (AAA system) associated with a first sub-net to provide a network connection descriptor for a target user;
receive the network connection descriptor for the target user from the first AAA system, said network connection descriptor comprising a network address identifier for a first device associated with the target user which is connected to the first sub-net, or comprising an indication that no device associated with the target user is connected to the first sub-net; and
convey an intercept descriptor to a mediation module in response to any change in target user connection status, said intercept descriptor comprising a target address corresponding to the network address identifier, and further comprising a mediation command to indicate how the intercept descriptor should be processed to carry out the intercept of IP traffic for the first target device.

20. The medium as recited in claim 19 wherein the instructions are further arranged to:
periodically request the first AAA system to provide a network connection descriptor for the target user; and
receive a network connection descriptor for the target user in response to each request for such network connection descriptor.

21. The medium as recited in claim 19 wherein the instructions are further arranged to:
request the first AAA system to provide a network connection descriptor for the target user only in response to changes in connection status; and
receive a network connection descriptor for the target user whenever such network connection status changes.

22. The medium as recited in claim 19 wherein the instructions are further arranged to:
query a secondary server to determine the target address corresponding to the network address identifier if the network connection descriptor does not already include the target address.

23. The medium as recited in claim 19 wherein the instructions are further arranged to:
communicate the target address to an access function device associated with the first sub-net.

24. The medium as recited in claim 19 wherein the instructions are further arranged to:
receive from the first AAA system a network connection descriptor for a second device associated with the target user which is simultaneously connected to the first sub-net, or comprising an indication that the second device associated with the target user is no longer connected to the first sub-net; and
convey an intercept descriptor to the mediation module in response to any change in connection status for the second device associated with the target user.

25. The medium as recited in claim 19 wherein the instructions are further arranged to:
request a second authentication, authorization, and accounting system (AAA system) associated with a second sub-net to provide a network connection descriptor for the target user;
receive from the second AAA system the network connection descriptor for the target user, said network connection descriptor comprising a network address identifier for a device associated with the target user which is connected to the second sub-net, or comprising an indication that no device associated with the target user is connected to the second sub-net; and
convey an intercept descriptor to a mediation module in response to any change in connection status for the device associated with the target user and connected to the second sub-net.

26. An intercept coordinator module comprising:
a first interface for communicating with a first authentication, authorization, and accounting system (AAA system) associated with a first sub-net, for requesting and receiving from the first AAA system a network connection descriptor for any device associated with a target user and connected to the first subnet; and
a second interface for communicating with a mediation module, for conveying to the mediation module an intercept descriptor for any target user device if a received network connection descriptor represents a change in connection status of the target user;
wherein each network connection descriptor comprises a network address identifier for a device associated with the target user which is connected to the first sub-net, or comprising an indication that no device associated with the target user is connected to the first sub-net; and
wherein said intercept descriptor comprises a target address corresponding to the network address identifier and a mediation command to indicate how the intercept descriptor should be processed to carry out the intercept of IP traffic for the first target device.

27. The module as recited in claim 26 further comprising:
a second interface for communicating with a second AAA system associated with a second sub-net, for requesting and receiving from the second AAA system a network connection descriptor for any device associated with a target user connected to the second subnet.

28. The module as recited in claim 26 implemented as instructions executable on a processor and encoded in a computer readable medium.

29. A method for facilitating a lawful intercept of IP traffic for a target user, said method comprising:
for each of one or more sub-nets to which a target user is authorized to connect, querying an authentication, authorization, and accounting system (AAA system) associated with the sub-net to provide a respective network connection descriptor for any target user device that is connected to the sub-net;
in response to any received network connection descriptor that represents a change in target user connection status for any of the connected target user devices, forming a respective intercept descriptor corresponding to the network connection descriptor; and
conveying the respective intercept descriptor to a mediation module to carry out the intercept.

30. A system comprising:
a mediation module;
an intercept coordinator module logically coupled to the mediation module, said intercept coordinator module for querying an authentication, authorization, and accounting system (AAA system) associated with a sub-net to provide a respective network connection descriptor for any device associated with a target user and connected to the sub-net, and in response to any change in connection status for any connected target user device, for conveying a respective intercept descriptor corresponding to the network connection descriptor to the mediation module to carry out the intercept.

31. The system as recited in claim 30 further comprising:
an access function (AF) device logically coupled to the mediation module and coupled to intercept data traffic for the sub-net, said AF device for receiving a target address from the mediation module and for conveying a copy of filtered IP traffic for the target address to the mediation module.
